(19) United States
(12) Patent Application Publication
(10) Pub. No.: US 2007/0206743 A1
(43) Pub. Date: Sep. 6, 2007

(54) SYSTEM AND METHOD FOR FACILITATING TRANSACTION OVER A COMMUNICATION NETWORK

(75) Inventor: Chong-Yie Chang, Taipei City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: INDUSTRIAL TECHNOLOGY RESEARCH INSTITUTE, Hsinchu (TW)

(21) Appl. No.: 11/554,610

(22) Filed: Oct. 31, 2006

Related U.S. Application Data
(60) Provisional application No. 60/776,906, filed on Feb. 23, 2006.

(51) Int. Cl. H04M 15/00

(52) U.S. Cl. 379/127.03

(57) ABSTRACT

A system capable of facilitating a transaction over a communication network comprises a transaction platform capable of storing at least one card identification number, providing a message to a communication device over the communication network requesting the selection of one of the at least one card identification number, and receiving transaction information regarding a transaction made at a business unit from the communication device over the communication network.

This application claims the benefit of U.S. Provisional Application No. 60/776,906, filed Feb. 23, 2006, which is herein incorporated by reference in its entirety.

### BACKGROUND OF THE INVENTION

The present invention relates generally to an electronic transaction system and, more particularly, to a system and method for facilitating transaction over a communication network through a communication device.

Plastic cards, for example, credit cards, debit cards, charge cards, and financial cards, are commonly used today as payment instruments. The low security of a conventional plastic card system presents numerous opportunities for fraud. For example, a credit card identification number may be stolen by a dishonest merchant or clerk during a transaction. It is desirable to have a system or method that provides a secure transaction for payment through plastic cards.

### BRIEF SUMMARY OF THE INVENTION

A system and method for facilitating transaction over a communication network using a communication device are disclosed. The system and method according to the present invention may provide a secure transaction so that confidential information such as the plastic card identification number of a cardholder will not be revealed to a third party during a transaction.

Examples of the present invention may provide a system capable of facilitating a transaction over a communication network that comprises a transaction platform capable of storing at least one card identification number, providing a message to a communication device over the communication network requesting the selection of one of the at least one card identification number, and receiving transaction information regarding a transaction made at a business unit from the communication device over the communication network.

Examples of the present invention may also provide a system capable of facilitating a transaction over a communication network that comprises a transaction platform capable of storing at least one card identification number, sending a message to a communication device including at least one token corresponding to the at least one card identification number, receiving a message from the communication device over the communication network indicating the selection of one of the at least one token, and receiving transaction information regarding a transaction made at a business unit from the communication device over the communication network.

Some examples of the present invention may provide a system capable of facilitating a transaction over a communication network that comprises a transaction platform capable of sending a list of card token over the communication network, requesting the selection of a card token from the list at a communication device, receiving a card token selected at the communication device over the communication network, receiving transaction information regarding a transaction to be made at a business unit from the communication device over the communication network, and sending a message to the business unit to confirm the transaction.

Examples of the present invention may provide a method capable of facilitating a transaction over a communication network that comprises storing at least one card identification number, receiving a message over the communication network including at least one token corresponding to the at least one card identification number, and receiving transaction information regarding a transaction made at a business unit.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the present invention and together with the description, serves to explain the principles of the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic diagram of a system capable of facilitating transaction over a communication network consistent with an example of the present invention; and

FIG. 2 is a diagram illustrating a method capable of financial transaction over a communication network consistent with an example of the present invention.

### DETAILED DESCRIPTION OF THE INVENTION

In this detailed description, for purposes of explanation, numerous specific details are set forth to illustrate embodiments of the present invention. One skilled in the art will appreciate, however, that examples of the present invention may be practiced without these specific details. Furthermore, one skilled in the art can readily appreciate that the specific sequences in which methods are presented and performed are illustrative and it is contemplated that the sequences can be varied and still remain within the spirit and scope of examples of the present invention.

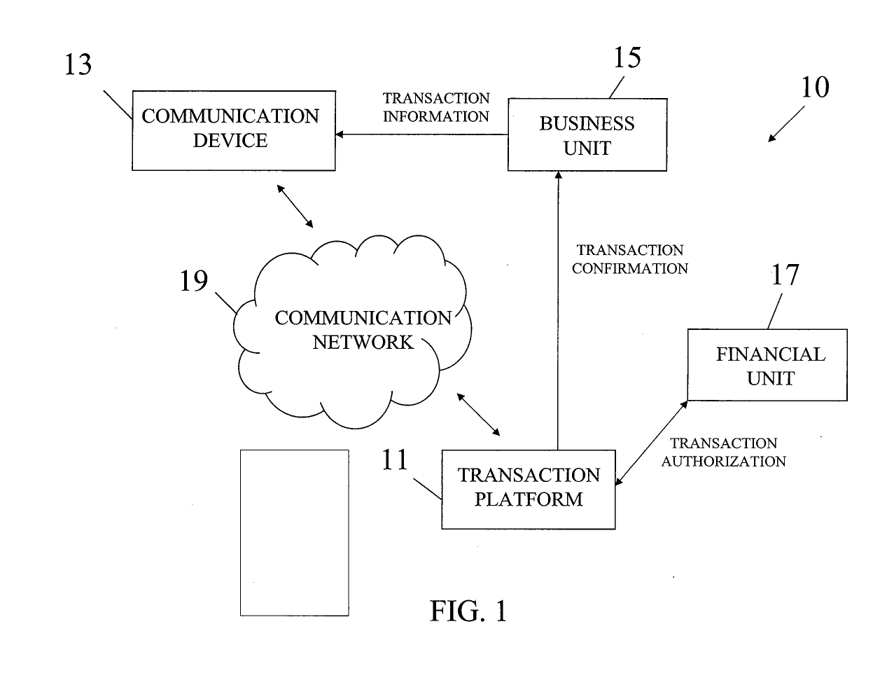

FIG. 1 is a schematic diagram of a system 10 capable of facilitating transaction over a communication network consistent with an example of the present invention. Referring to FIG. 1, the system 10 includes a transaction platform 11, a communication device 13, a business unit 15, a financial unit 17 and a communication network 19. The transaction platform 11, which may include a computer server, processes plastic card transactions in the system 10. A user of the system 10 is requested to register in system 10 at the first time when he or she uses the system 10. The transaction platform 11 verifies whether a user has registered in system 10, and does not provide service to a user until he or she is registered to obtain an identity such as a credential assigned by system 10. The communication device 13 in one aspect includes one of a cellular phone or a personal digital assistant (“PDA”) that supports Internet and networking features, and may include an image interface such as a digital camera. In another aspect, the communication device 13 includes one of a notebook computer and a personal computer. The communication device 13 and transaction platform 11 communicate with one another via the communication network 19, which includes but is not limited to a public switched telephone network (“PSTN”), an Ethernet, a general packet radio service (“GPRS”) network, a third-generation (3G) mobile telephone network or a wireless local area network (“WLAN”).

A user of the system 10, who has applied for a plastic card from the financial unit 17, is also a cardholder. The plastic card has a card identification number assigned by the financial unit 17, which includes but is not limited to a credit provider, often a bank. In other examples consistent with the present invention, a user is a cardholder of a plurality of cards authorized by different financial units. The user is requested to provide at least one card identification number to the transaction platform 11. The transaction platform 11 stores the user identity assigned to a user upon registration and at least one card identification number associated with the user.

When a user of the system 10 purchases a product or consumes a service from the business unit 15, the user communicates with the transaction platform 11 by showing the user identity through communication device 13 over the communication network 19. In one example consistent with the present invention, the user sends a message requesting a list of at least one card identification number. In response to the message, the transaction platform 11 transmits a message to communication device 13 over the communication network 19 including such a list and requesting the user to select one card identification number from the list. The message from the transaction platform 11 may include graphic illustration and/or textual description to facilitate the user to select a plastic card corresponding to the one card identification number. Furthermore, the transaction platform 11 also transmits a token, which is machine recognizable, corresponding to one of the at least one card identification number.

During the purchase, the business unit 15 provides transaction information regarding the purchase to the user. The transaction information, which may include a transaction code, a monetary amount or a merchant code corresponding to the purchase, is accessible by the communication device 13. In one example consistent with the present invention, the transaction information in the form of a barcode is taken by a digital camera of the communication device 13. In another example, the user enters the transaction information in the form of a string of digits through the keypad of the communication device 13. In still another example, the communication device 13 includes a radio-frequency (“RF”) interface for receiving the transaction information via an RF channel using a conventional telecommunication technique that supports short-range wireless communications. Examples of the short-range telecommunications technique include but are not limited to an infrared (“IR”), Bluetooth, Ultra Wide Band (“UWB”), ZigBee, Worldwide Interoperability for Microwave Access (“WiMax”) and Near Field Communication “NFC”) technology. The Bluetooth refers to an industrial specification for wireless personal area networks (“PANs”), which provides a way to connect and exchange information between devices such as PDAs, cellular phones, laptops, personal computers (“PCs”), printers and digital cameras via a globally available short range radio frequency. The UWB refers to a wireless communications technology that support transmission of data at a relatively high speed ranging from approximately 40 to 60 megabits per second and eventually up to 1 gigabit per second. The ZigBee refers to a published specification set of high level communication protocols designed to use small, low power digital radios for wireless personal area networks (“WPANs”). The WiMax refers to a certification mark for products. Products that pass the WiMAX tests are capable of forming wireless connections between them to permit the carrying of internet packet data. The NFC Forum is a non-profit industry association formed to advance the use of NFC short-range wireless interaction in consumer electronics, mobile devices and PCs.

After the transaction information is obtained, the user transmits the transaction information to the transaction platform 11 through the communication device 13 over the communication network 19. In response to the transaction information, the transaction platform 11 verifies whether a card corresponding to the selected card token for the purchase is valid and able to accept the charge. If confirmative, the transaction platform 11 sends a message including, for example, an authorization code to the business unit 15 to confirm the purchase. If the card is invalid or the charge exceeds a credit limit, the transaction platform 11 will not accept the card in this purchase. In another example, the financial unit 17 verifies whether a card corresponding to the selected card token for the purchase is valid and able to accept the charge, and sends a message indicating the result of verification to the transaction platform 11.

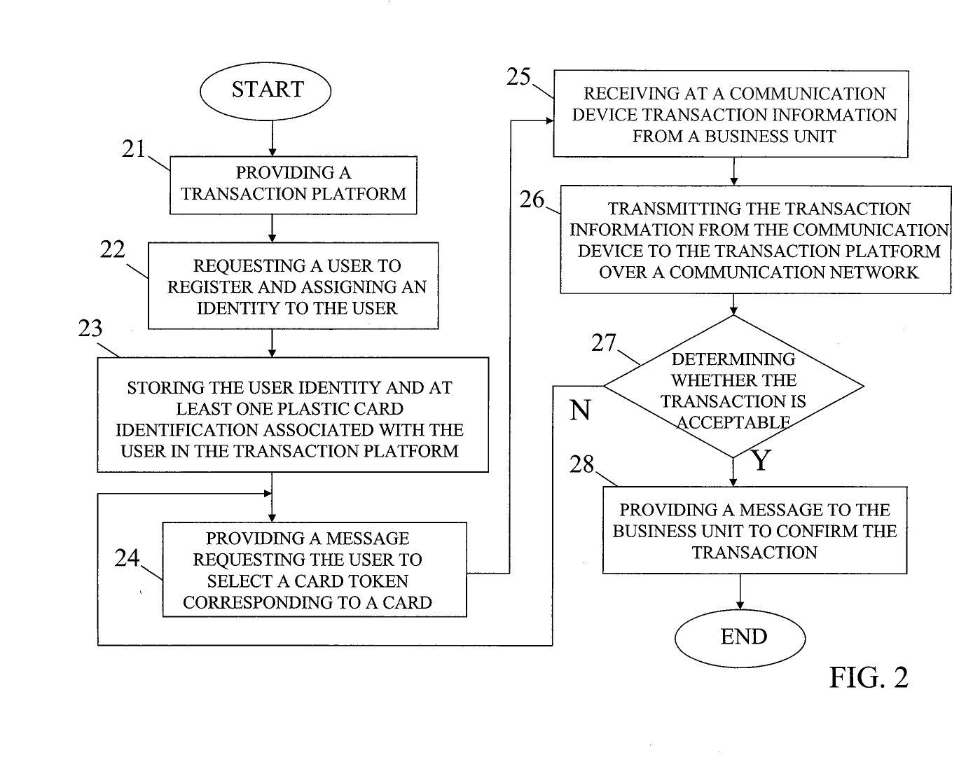

FIG. 2 is a diagram illustrating a method capable of financial transaction over a communication network consistent with an example of the present invention. Referring to FIG. 2, at step 21, a transaction platform is provided. At step 22, a user is requested to register at the transaction platform to obtain a user identity at the first time he or she uses the system. The user identity and at least one card identification number associated with the user are stored in the transaction platform at step 23. Prior to a purchase, the user communicates with the transaction platform by showing the user identity through a communication device over a communication network. In response to the user identity, the transaction platform provides a message to the communication device over the communication network requesting the user to select a card token corresponding to a card authorized by a financial unit at step 24. Transaction information including, for example, a transaction code, a monetary amount and a merchant code, is received by the communication device at step 25 and then sent to the transaction platform at step 26. Next, at step 27, the transaction platform or a financial unit associated with the card selected by the user for the purchase determines whether the card is valid or the user's credit is sufficient to cover the purchase. At step 28, a message is sent to a business unit from the transaction platform to confirm the purchase if the card is valid and the charge does not exceed a credit limit, which is the maximum amount of credit that the financial unit will extend to the user or the maximum that the financial unit will allow the user to borrow on the card. If the card is not valid or the user's credit is not sufficient to cover the purchase, the transaction platform sends a message requesting the user to select another card.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. A system capable of facilitating a transaction over a communication network comprising a transaction platform capable of storing at least one card identification number, providing a message to a communication device over the communication network requesting the selection of one of the at least one card identification number, and receiving transaction information regarding a transaction made at a business unit from the communication device over the communication network.

2. The system of claim 1, wherein the transaction platform is capable of assigning a user identity and storing at least one card identification number associated with the user identity.

3. The system of claim 1, wherein the transaction platform is capable of receiving a message sent from the communication device over the communication network requesting a list of at least one card identification number.

4. The system of claim 1, wherein the transaction information includes a barcode.

5. The system of claim 1, wherein the communication device includes at least one of a camera or a radio-frequency interface for obtaining the transaction information.

6. The system of claim 1, wherein the transaction platform provides a message to the communication device over the communication network requesting the selection of one of at least one token corresponding to one of the at least one card identification number.

7. The system of claim 1, wherein in response to the transaction information the transaction platform sends a message to the business unit indicating whether a card selected is valid or the transaction is approved.

8. A system capable of facilitating a transaction over a communication network comprising a transaction platform capable of storing at least one card identification number, sending a message to a communication device including at least one token corresponding to the at least one card identification number, receiving a message from the communication device over the communication network indicating the selection of one of the at least one token, and receiving transaction information regarding a transaction made at a business unit from the communication device over the communication network.

9. The system of claim 8, wherein the communication device includes a digital camera capable of obtaining the transaction information in the form of a barcode.

10. The system of claim 8, wherein the communication device includes a radio-frequency interface for obtaining the transaction information via a radio-frequency channel.

11. A system capable of facilitating a transaction over a communication network comprising a transaction platform capable of sending a list of card token over the communication network, requesting the selection of a card token from the list at a communication device, receiving a card token selected at the communication device over the communication network, receiving transaction information regarding a transaction to be made at a business unit from the communication device over the communication network, and sending a message to the business unit to confirm the transaction.

12. The system of claim 11, wherein the communication device includes at least one of a camera or a radio frequency interface for obtaining the transaction information.

13. The system of claim 11, wherein the transaction platform is capable of assigning a user identity, and storing the user identity and at least one card identification number associated with the user identity.

14. A method capable of facilitating a transaction over a communication network, comprising:
storing at least one card identification number;
receiving a message over the communication network including at least one token corresponding to the at least one card identification number; and
receiving transaction information regarding a transaction made at a business unit.

15. The method of claim 14, further comprising receiving a message over the communication network requesting a list of the at least one token.

16. The method of claim 14, further comprising providing a message over the communication network requesting the selection of one of the at least one token.

17. The method of claim 14, further comprising assigning a user identity and storing the at least one card identification number associated with the user identity.

18. The method of claim 14, further comprising obtaining the transaction information through a camera.

19. The method of claim 14, further comprising obtaining the transaction information through a radio-frequency interface device.

20. The method of claim 14, further comprising sending a message over the communication network including one of the at least one token through a communication device.
